(19) United States
(12) Patent Application Publication
(10) Pub. No.: US 2025/0180424 A1
(43) Pub. Date: Jun. 5, 2025

(54) PRESSURE GAUGE ASSEMBLY WITH INTEGRATED VENT SYSTEM AND METHODS OF FABRICATING SAME

(71) Applicant: Custom Sensors & Technology, Fenton, MO (US)

(72) Inventor: Thomas Mark Kornblum, Pevely, MO (US)

(21) Appl. No.: 19/049,362

(22) Filed: Feb. 10, 2025

Related U.S. Application Data
(63) Continuation-in-part of application No. 18/101,504, filed on Jan. 25, 2023.

(51) Int. Cl. G01L 19/06; G01L 19/00; G01L 19/14

(52) U.S. Cl. CPC G01L 19/0618; G01L 19/0038; G01L 19/143; G01L 19/0084

(57) ABSTRACT

A pressure gauge includes a housing and a pressure sensor. The housing includes an access, a hollow chamber, and a vent system. The housing includes a hollow bore extending therethrough. The housing also includes a first connector and a second connector that is opposite the first connector. The first connector is concentrically aligned with the hollow bore for allowing fluid to enter the hollow bore. The second connector is concentrically aligned with the hollow bore for allowing fluid to exit the hollow bore. The access is oriented generally perpendicularly to the hollow bore. The pressure sensor is positioned within the access and is recessed from the hollow bore. The hollow chamber is sized to contain the pressure sensor therein. The vent system includes an opening and a protective cover. The vent system opening is substantially concentrically aligned with the pressure sensor and the protective cover extends across the vent system opening.

### CROSS REFERENCE TO RELATED APPLICATIONS

This application is a continuation-in-part of U.S. patent application Ser. No. 18/101,504, filed Jan. 25, 2023, the entirety of which is herein incorporated by reference.

### FIELD OF THE INVENTION

The present disclosure relates to a pressure gauge, and more specifically, to a pressure gauge formed of a pressure sensor in a two-part housing or fitting that includes a vent system that facilitates enhancing the accuracy of the pressure sensor contained within the housing. Moreover, in the exemplary embodiment, only one part of the housing is exposed to the process stream and the housing when fully assembled, encloses the pressure sensing electronics. Because the housing is vented, the pressure at the back of the pressure sensor should be the same as ambient pressure. As such, a reliable and accurate relative pressure measurement is facilitated using a sturdy pressure gauge that is less expensive to construct as compared to known pressure gauges.

### BACKGROUND

There are a number of places where material production or activity creates what is effectively a process stream. Continuous manufacturing techniques, as well as processes that are continuously acting on elements, create a near constant output of an end product, or at least do so within a batch of production. Bioprocess fluid streams are an example of a process stream commonly used in the manufacture of biological materials. Many activities in chemical, petro-chemical, pharmaceutical, waste processing, food, and beverage manufacturing processes, involve the monitoring of process streams that produce an end product.

In a large number of process stream applications, knowledge of the pressure within the tubing carrying the fluid forming the process stream is essential to the success of the process. For example, in the production of biopharmaceuticals, accurate pressure monitoring and measuring is often essential. In order to measure the pressure in a fluid stream that is being channeled through flexible tubing, that is commonly used in such processes, an in-line pressure gauge is typically used. At least some known in-line pressure gauges have traditionally mounted the pressure sensor within a fitting between an inlet and outlet port that enables the process stream to flow into the pressure gauge (which acts as a part of the fluid path), to detect the pressure of the portion of the stream within the pressure gauge, and then to exhaust the stream back into the tubing downstream from the pressure gauge.

In biochemical manufacture, it is often essential that the fluid handling pathway be maintained in a manner that facilitates preventing microbial contamination. Specifically, during manufacturing, an uncontaminated environment has to be maintained throughout the process. Thus, the process stream is typically sealed from the external environment. Further, in order to avoid contamination between different batch runs during the process, the fluid handling pathway often needs to be sterile, or at least completely clean, before each process batch run. Because of the difficulty in cleaning the inside of small diameter tubing, this has traditionally meant that the tubing used to carry the process stream, and the various sensors and devices attached to it, and which have the process stream pass flowing therethrough, are commonly disposed of between batch runs. Thus, a large variety of components that are used in such process stream applications are typically disposed of after every batch run, including but not limited to only including, storage containers, tubing, filters, and/or connectors. Often, the process sensors, such as the pressure gauge, are often disposed of as well.

Accordingly, it would be desirable to provide a process pressure monitoring device that maintains minimal microbial contamination while being universally adaptable to numerous process applications and that is reliable, provides accurate and repeatable results, and that is relatively inexpensive to fabricate.

### BRIEF SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there is a need for a pressure gauge, and particularly a housing or fitting for a pressure sensor which provides for reduced cost of construction of any portion which is to be disposed of between batches. The pressure gauge will typically be fabricated from two housing components that are interconnected in a self-aligning fashion. However, the bore that channels fluid through the housing for pressure measurement is confined to a single one of the two housing components.

In one aspect, a pressure gauge is provided. The pressure gauge includes a housing and a pressure sensor. The housing includes an access, a hollow chamber, and a vent system. The housing includes a hollow bore extending therethrough. The housing also includes a first connector and a second connector that is opposite the first connector. The first connector is concentrically aligned with the hollow bore for allowing fluid to enter the hollow bore. The second connector is concentrically aligned with the hollow bore for allowing fluid to exit the hollow bore. The access is oriented generally perpendicularly to the hollow bore. The pressure sensor is positioned within the access and is recessed from the hollow bore. The hollow chamber is defined therein and is sized to contain the pressure sensor therein. The vent system includes an opening and a protective cover. The vent system opening is substantially concentrically aligned with the pressure sensor and the protective cover extends across the vent system opening.

In another aspect, a pressure gauge for use in measuring the pressure of a fluid is provided. The pressure gauge includes a housing and a pressure sensor. The housing includes an access, a hollow chamber, and a vent system. The housing includes a hollow bore extending therethrough. The housing also includes a first connector and a second connector that is opposite the first connector. The first connector is concentrically aligned with the hollow bore for allowing fluid to enter the hollow bore. The second connector is concentrically aligned with the hollow bore for allowing fluid to exit the hollow bore. The access is oriented generally perpendicularly to the hollow bore. The pressure sensor is positioned within the access and is recessed from the hollow bore. The pressure sensor is positioned for measuring pressure of the fluid flowing through the hollow bore. The hollow chamber is defined therein and is sized to contain the pressure sensor therein. The vent system includes an opening, a cavity, and a protective cover. The vent system opening is substantially concentrically aligned with the pressure sensor. The protective cover extends across the vent system opening, and the cavity has a pre-defined volume between the pressure sensor and the vent system opening. The cavity is sized to facilitate equalizing the pressure between the pressure sensor and the environment surrounding the pressure gauge.

In yet another aspect, a method of fabricating a pressure gauge for use in measuring pressure flowing through a pressure gauge is provided. The method includes providing a lower housing portion including a hollow bore extending therethrough, wherein the hollow bore is sized to enable fluid to flow therethrough from a first end to a second end of the hollow bore, and coupling a pressure sensor within an access defined within the housing such that the pressure sensor is recessed from the hollow bore and is positioned to take pressure measurements of fluid flowing through the hollow bore. The method also includes forming a vent system in an upper portion of the housing wherein the vent system has an opening that is exposed to the ambient environment and a cavity having a pre-defined volume that is substantially concentrically aligned with the pressure sensor when the housing is fully assembled. In addition, the method includes coupling the upper portion of the housing to the lower portion of the housing such that the pressure sensor is contained in position within the access and such that the vent system opening is substantially concentrically aligned with respect to the pressure sensor and coupling a protective cover to the vent system to prevent ingress into the vent system opening.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a front perspective view of an exemplary embodiment of a pressure gauge assembly with pressure sensing electronics included therein.

FIG. 2 is a rear perspective view of the pressure gauge assembly shown in FIG. 1.

FIG. 3 is a top view of the pressure gauge assembly shown in FIG. 2.

FIG. 4 is a ghost view of the pressure gauge assembly shown in FIG. 2 and illustrating the pressure sensing electronics housed therein.

FIG. 5 is a cross-sectional view of the pressure gauge housing shown in FIG. 2 and taken along line 5-5.

FIG. 6 is a top perspective view of the fitment portion of the housing shown in FIG. 1.

FIG. 7 is top perspective view of an alternative embodiment of pressure gauge assembly with pressure sensing electronics included therein.

FIG. 8 is a cross-sectional view of the pressure gauge assembly shown in FIG. 7 and taken along line 8-8.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

For purposes of clarity, it should be recognized that terminology when it comes to small sensors can be somewhat fluid. For example, when one refers to a “pressure gauge” or “pressure sensor” it should be recognized that such term can refer to both a macro scale object, but also, and more accurately, a component thereof. Specifically, a “pressure sensor” is usually simply a small electronic device which is sensitive to changes in pressure and produces a different electrical signal (or modifies an applied signal) when exposed to different pressures.

However, for such a pressure sensor to carry out pressure measurements, it typically needs to be placed in contact with the fluid for which it is to take pressure measurements. Access to the fluid is often through the form of a housing for the pressure sensor which is designed to transport some of the fluid to the pressure sensor and then return the fluid to the process stream. This housing is further typically designed to be placed in-line with other fluid handling apparatus that handle the process stream. Thus, a “pressure sensor” in common parlance can sometimes be used to mean the pressure sensor; the pressure sensor, associated electronics, and the housing as a whole; or any combination of these things.

In the present discussion, in order to help resolve potential ambiguity around the term “pressure sensor” and other such terms this discussion will generally use the following terminology. A “pressure sensor” will generally be used to refer to the actual piece of material which a change in pressure effects. In many respects, this is a traditional pressure transducer or more generally a force collector. It may also have some associated electronic structures (e.g., wiring, circuits, or interconnects) that are necessary for it to function in this role.

“Pressure sensing electronics” will refer to the pressure sensor along with any additional associated electronics which enable the pressure sensor to produce a coherent electronic signal that is, in some capacity, indicative of an amount of pressure amount or change, and to transmit those signals to some form of processor. Finally, a “pressure gauge” or a “pressure gauge assembly” in this disclosure will be the pressure sensing electronics (including the pressure sensor) along with a housing which is designed to be positioned within a system to provide access to the fluid upon which a pressure measurement will be taken by the pressure sensor.

In the present disclosure, the primary environment on which pressure measurements are being taken includes the pressure of a fluid process stream that is enclosed within a contained volume flowing through tubing or piping. In order to expose the pressure sensor to the fluid in the tubing, the pressure sensor will be positioned within a housing that includes a fitting for exposure of the pressure sensor to the stream by directing the stream, or a portion thereof, into itself. Pressure sensing by the pressure sensor will occur when the fluid is within the housing. The housing will also typically include sufficient additional pressure sensing electronics to enable the generation of an electrical signal which can be transmitted from the resultant pressure gauge to an external electronic device or processor. Often, the electronic device or processor is general purpose computer running software, or a dedicated hardware processor, designed for such interpretation. The pressure gauge may measure static or dynamic pressure depending on the provided pressure sensor and pressure sensing electronics as well as any attached processors.

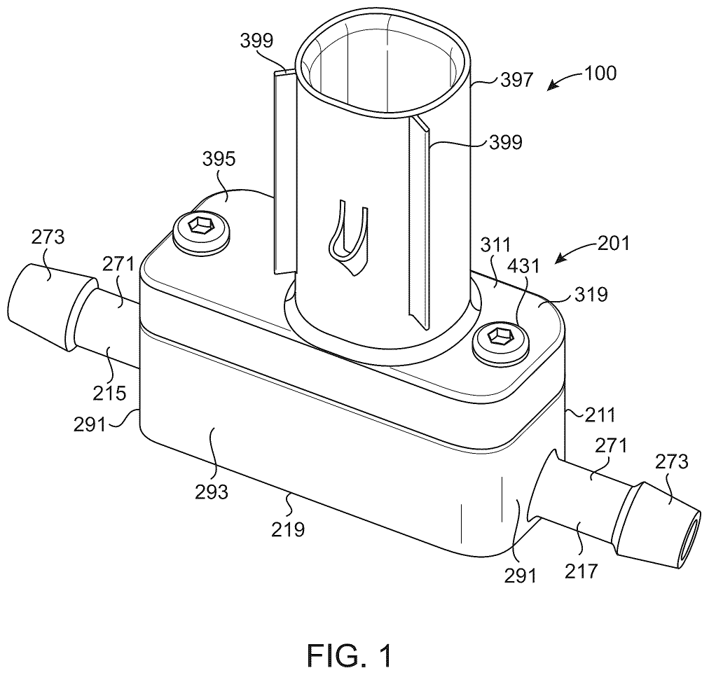

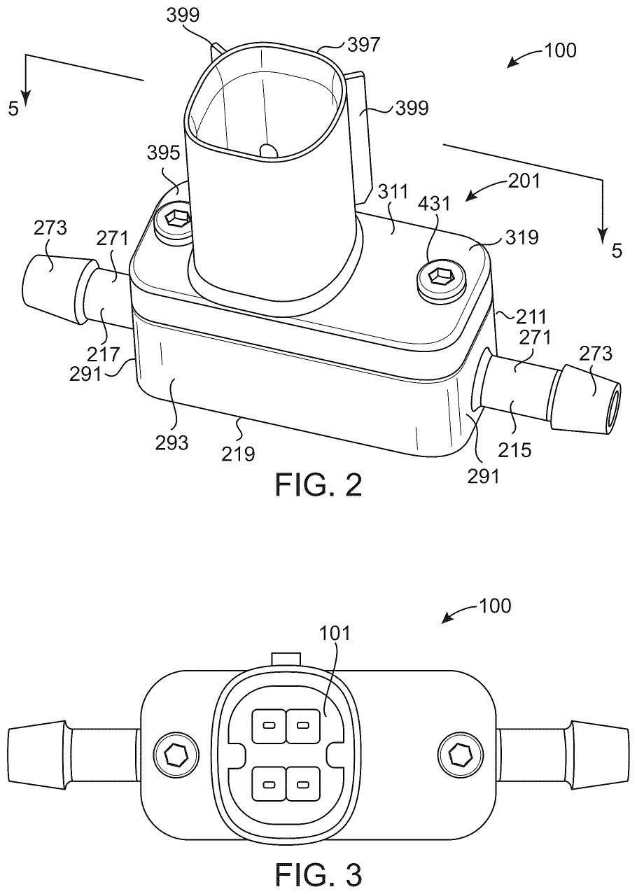

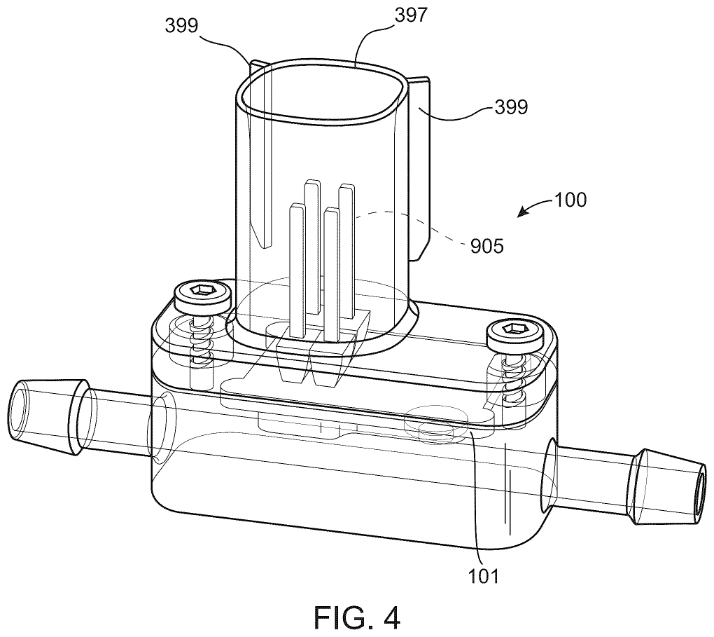

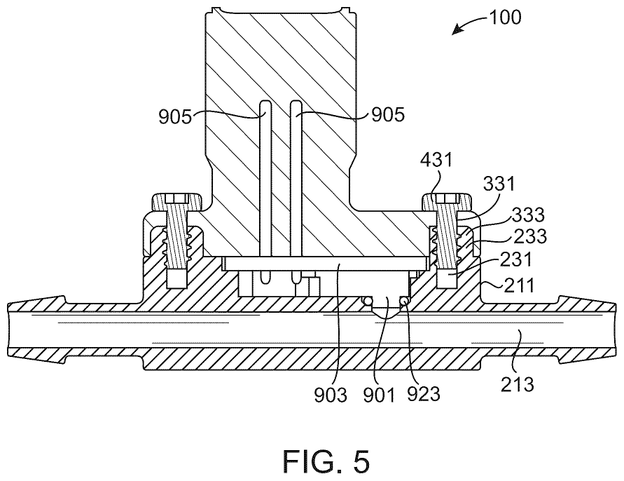

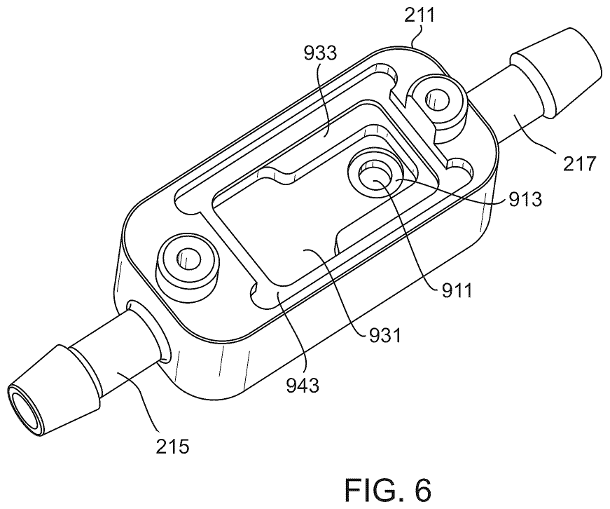

FIGS. 1-6 illustrate various images of an exemplary pressure gauge assembly or pressure gauge (100) and components thereof. More specifically, FIGS. 1 and 2 provide different perspective views image of the housing (201) of the pressure gauge (100), while FIG. 3 illustrates a top view of the housing (201). FIGS. 4 and 5 provide respective ghost and cut-away images of the pressure gauge (100) to better show relative positioning of the various pressure sensing electronics (101) contained within the housing (201). FIG. 6 provides a view of the fitment portion (211) of the housing (201) with the mount portion (311) and pressure sensing electronics (101) removed to better show the internal structure of the fitment (211).

The housing (201) is generally designed to house and enclose the pressure sensor (901) and associated pressure sensing electronics (101) and to enable the pressure sensor (901) to measure the operating pressure within a process stream that is flowing through the fitment portion (211) of the housing (201) via a hollow bore (213) defined within and extending through the housing (201). As can be best seen in FIGS. 1 and 2, in the exemplary embodiment, the housing (201) constructed of two major pieces, the fitment portion (211) and the mount portion (311) that are coupled together to form the housing (201) that contains the pressure sensing electronics (301) therein. The fitment and mount portions (211 and 311, respectively) are designed to generally self-align with each other such that assembly of the housing (201) is simplified, murphy-proofed, and consistent.

The fitment portion (211) is designed primarily to carry the portion of the process stream upon which the pressure sensor (901) is to take measurements, and to support the pressure sensor (901) in a position where it can take such measurements. In the exemplary embodiment, the fitment portion (211) includes a body structure (219) including two tubing connectors (215) and (217) attached thereto. In the exemplary embodiment, the body structure (219) and connectors (215) and (217) integrally formed from a single monolithic piece of material (e.g., machined via traditional negative manufacturing from a single piece of source material). Alternatively, the body structure (219) and/or at least one connector (215) and/or (217) may be formed as separate components that are sealingly coupled together to form a unitary component.

The body structure (219) in the exemplary embodiment is generally in the form of a rectangular prism with rounded edges. Alternatively, the body portion (219) may have any other shape that enables the body portion (219) to function as described herein. The tubing connectors (215) and (217), as best shown in FIGS. 1 and 6 extend from the shorter faces (291) of the body structure (219) as opposed to the longer faces (293), and are generally parallel to the major centerline axis (not shown) of the body structure (219) but, again, such an orientation or arrangement is not required.

In the exemplary embodiment, each of the tubing connectors (215) and (217) is generally in the form of an elongated cylinder (271) that includes an extended cuff (273) generally in the form of a conical frustum with the wider base extending from the end of each cylinder (271). This arrangement forms each of the connectors (215) and (217) into the shape of a barbed hose connector as that term would be generally understood by one of ordinary skill in the art. Barbed hose connectors are a well-known and are a common form of connector used for interfacing with flexible tubing. This form for tubing connector (215) and (217) is valuable in many smaller process stream applications such as in the production of biopharmaceuticals as it is a common form of connector to tubing used in such systems. It is, however, not the only form of tubing connector (215) or (217) that may be used and other forms of tubing connector (215) or (217) may be used in alternative embodiments.

The tubing connectors (215) and (217) may also come in a variety of lengths and diameters depending on the nature of the connection to be made, the process stream, or other considerations. Similarly, the body structure (219) may be a variety of sizes and the diameter and length of the bore (213) may also be altered based on similar considerations. Still further, the tubing connectors (215) and (217) may be replaced by other forms of connectors if the pressure gauge (100) is to be connected to or within a different system including if the process stream and/or if fluid was to be provided to the hollow bore (213) via a different process. Thus, the structure of tubing connectors (215) and (217) is by no means a required form of connector and other connectors may be used in alternative embodiments.

It should be noted that connectors (215) and/or (217) are not limited to only being fabricated as standard hose barbs and rather, can be fabricated as any other connecting or fastening mechanism that enables pressure gauge (100) to couple to other process components, as described herein. For example, at least one of the connectors (215) and/or (217) may be formed as, but is not limited to only being formed as, a hose bead, a push-to-connect fitting, a quick connect fitting, a flare, a twist and lock fitting, a threaded fitting, and/or any other connecting means, including a combination of any of the aforementioned alternative ends, that enables pressure gauge (100) to easily couple to other process components. In another alternative embodiment, at least one of the connectors (215) and/or (217) may be formed with a flange that extends radially outward from the cylinder (271) that not only enables the pressure gauge (100) to couple to other process components, but also functions as a stop that facilitates limiting how far tubing, for example, can be mounted to the pressure gauge (100).

A hollow bore (213) is defined within the internal volume of the fitment portion (211). The hollow bore (213) extends generally axially through both connectors (215) and (217) and through the body structure (219). The hollow bore (213) will typically be formed cylindrically and will extend from the outer ends of each of the tapered frustums (273) through each cylinder (271) and through the body structure (219) in a generally linear fashion. However, the linearity is not required and in alternative embodiments, the bore (213) may be formed in any other path orientation or shape that enables the pressure gauge (100) to function as described herein. Although in the exemplary embodiment, a diameter of the bore (213) is substantially constant, in alternative embodiments, the diameter of the hollow bore may vary within the connectors (215) and (217) and/or within the body structure (219).

As can be best seen in FIG. 6, body structure (219) there is an access (911) defined in the body structure (219) and which has an axis generally perpendicular to the major axis of the hollow bore (213). The access (911) is in fluid communication with the hollow bore (213). This will typically be the only place within the body structure (219) where fluid flowing through the hollow bore (213) could leave the bore (213), except that egress of fluid through the access (911) will be prevented by the pressure sensor (901) and the sealing ring (923) as described in more detail below. Thus, fluid entering the bore (213) via one connector (215), travels through the bore (213) and past the access (911) before to the other connector (217) without contacting any surface except the walls defining the bore (213) which are formed by the body structure (219) and connectors (215) and (217), and are further bordered by the pressure sensor (901) and possibly the sealing ring (923) when the sensor (901) and sealing ring (923) are seated within the access (911).

Attached to the top of the body structure (219), when the housing (201) is formed, is the mount portion (311). The mount portion (311) is typically designed to support and align various electronic components of the pressure sensing electronics (101) within the housing (201). More specifically, connection of the mount portion (311) to the fitment portion (211) facilitates retaining the pressure sensing electronics (101) in position and encases them within the housing (201). The mount portion (311) also provides for a physical connection point for to enable interconnection of the pressure sensing electronics (101) via a cable and mating connector to an external computer, processor, or other device used to interpret signals transmitted by the pressure sensing electronics (101). This also enables the signals transmitted by the pressure sensor (901) to ultimately be interpreted by a human user, or to be used by other electronics as desired in the process being monitored by the pressure gauge (100).

The mount portion (311) is generally formed of a base (319) which in the exemplary embodiment, is also generally in the form of a rectangular prism with rounded edges of similar dimensionality to the fitment portion (211) such that the mount portion (311) is seated generally flush against a major surface of the body structure (219). The base (319) is typically of reduced width (i.e., has a reduced thickness) as compared to the body structure (219), and functions as a cap to retain the pressure sensing electronics (101), and particularly the circuit board (903), in position through pressure. Importantly, the mount portion (311) does not define any portion of the bore (213) extending through the pressure gauge 100. Thus, fluid flowing through the bore (213) will never contact the mount portion (311).

Extending from the top major surface (395) of the base (319) is a socket (397). In the exemplary embodiment, the socket (397), as best shown in FIG. 2, is designed to interface with the physical (as opposed to electrical) connection components of additional attached electronics. In the depicted embodiment, the socket (397) is configured to interconnect to a standard four pin Molex™ MX150 connector and, thus, includes protrusions (399) that are sized and oriented to interface with such a connector in the manner understood by one of ordinary skill in the art.

In the depicted embodiment, the socket (397) extends generally perpendicularly from the major surface (395) of the base (319) as shown. This orientation corresponds to the positioning of the pins (905) to enable interconnection of the pressure gauge (100) with a Molex™ connector or any other similar connector when the pins (905) are mounted on the circuit board (903) as shown in FIGS. 4 and 5. In alternative embodiments, this orientation is not required and the socket (397) may extend from the base (319) at any other relative angle. For example, the socket may extend at an angle relative to the major axis of the socket (397) such that the socket (397) is generally parallel to the major surface of the base (319) while still allowing for rotation about the base (319) (e.g. within the plane of the sockets (397) major axis in this orientation). The socket (397) can also be oriented at any angle between substantially parallel to and substantially perpendicular with the major plane of the base (319). At any of these angles, the socket (397) can again be rotated about the base (319). These alternative orientations will typically require that the pins (905) be moved or coupled to the circuit board (903) in a different manner so that the pins (905) are correctly positioned in the socket (397) to enable the electrical connection as would be understood by one of ordinary skill in the art. However, such alternative designs can satisfy necessary space or design constraints outside the scope of this disclosure.

The base (319) also includes two recesses (333) each of which includes a hole (331) extending through a wall (in the depicted embodiment, it would typically be called the end) thereof. The recesses (333) are designed to act as a female connector and engage and mate with corresponding pillars (233) which extend from the body structure (219) and act as the corresponding male connector when the fitment portion (211) and mount portion (311) are interconnected. Each of the pillars (233) also includes a hole (231) which extends therethrough. Holes (331) and holes (231) are designed to be engaged by screws (431).

When the pillars (233) and recesses (333) are aligned, the hole (331) in each recess (333) is substantially concentrically aligned with a corresponding hole (231) defined in the mating pillar (233). Thus, when the base (319) is placed on the body structure (219), the pillars (233) and recesses (333) will mate and the corresponding holes (231) and (331) will be concentrically aligned. This will self-align the fitment portion (211) with the mount portion (311). The screws (431) can then be threadably coupled within the holes (331) typically engaging the material of the base (319) and passing through those holes (331) into holes (231), wherein the screws (431) also engage the material of the body structure (219). The screws (431) are generally thread forming screws of a type known to those of ordinary skill in the art and facilitate interconnecting and securely coupling the base (319) and body portion (219) together in proper alignment, such that the mount (311) is pressed into the body portion (219) of the fitment (211) and the the circuit board (903) is sandwiched between the base (319) and body portion (219). In the exemplary embodiment, the holes (331) and (231) are not pre-threaded prior to the screw (431) insertion to assist with the self-alignment and the securely coupling of the mount portion (311) with the fitment portion (211). Moreover, using self-tapping screws facilitates avoiding misalignment of threads between the holes (331) and (231).

The fitment portion (211) and the mount portion (311) will typically be constructed of two different materials, but that is by no means required. Alternatively, the fitment portion (211) and/or the mount portion (311) can be manufactured in any known method and with any known materials that enables the pressure gauge (100) to function as described herein. Specifically, in the exemplary embodiment, the fitment portion (211) will typically be machined using negative manufacture from a solid piece of material as indicated above. As such, it may be manufactured of any traditional material and may be designed to withstand any predefined operating pressure that may be present within the enclosed bore (213). Further, the bore (213) will often need to meet certain medical grade manufacturing requirements in material and quality, and the fitment portion (211) may need to be manufactured from a material that enables it to be sterilized via chemical or heat treatment should the pressure gauge (100) be used in biomedical manufacturing processes. Thus, the material used in manufacturing the fitment portion (211) may be variably selected to meet any or all of these requirements.

However, as should be apparent from the structure described herein, the mount portion (311) does not have any contact with the process stream flowing through the enclosed bore (213) and, thus, does not need to meet these same requirements. Rather, the function of the mount portion (311) is simply to retain the pressure sensor (901) in place within the fitment portion (211) i.e., as the circuit board (903) is sandwiched between the mount portion (311) and the fitment portion (211) in the hollow chamber (931), and to facilitate easy interconnection of external electronics via the socket (397). Thus, the mount portion (311) will typically have no need to withstand the operating pressures within the hollow bore (213) and such, it will not contact the process stream, and thus, has no need to be sterilized or fabricated from a medical grade material. Thus, the mount portion (311) may be constructed inexpensively and more easily, as compared to the fitment portion (211). For example, in one embodiment, the mount (311) is 3D printed using any appropriate material.

FIGS. 2-5 illustrate exemplary depictions showing how the pressure sensing electronics (101) are positioned within the housing (201) and sandwiched between the mount portion (311) and the fitment portion (211). The pressure sensing electronics (101) will generally include a circuit board (903) and the pressure sensor (901) that is coupled to and extends from the circuit board (903). In the exemplary embodiment, the pressure sensor (901) extends into the access (911) which enables pressure detection within the enclosed bore (213). A portion of the pressure sensor (901) may, thus, be in contact with the fluid flowing through the enclosed bore (213) or may be connected to a component that is in contact with the process fluid. For example, in one embodiment, the access (911) may be sealed from the bore (213) via a cap or similar structure that can transmit the operating pressure to the pressure sensor (901) which would be located in the hollow chamber (931). In such an embodiment, the pressure sensor (901) would be fluidly sealed from the bore (213) via the cap in the access (911), rather than the pressure sensor (901) itself sealing the access (911) from the bore (213).

In the exemplary embodiment, a surrounding depression (913), i.e., a recessed countersink area, is circumscribes the access (911) and the portion of the pressure sensor (901) that extends into the access (911). The depression (913) provides a recessed seat sized to hold a seal (923) in sealing contact about the access (911) thus sealing the hollow bore (213) from the rest of the pressure sensing electronics (101). This seal (923) facilitates enhancing the accuracy of pressure measurements and prevents the circuit board (903) from contacting the process stream flowing through the enclosed bore (213).

In the depicted embodiment, the depression (913) is generally cylindrical and is sized to hold an “O-ring” seal (923) fabricated from a compressible material that is suitable to withstand exposure to the given fluid to which the pressure gauge (100) is to be exposed. In an alternative embodiment, the depression (913) may be in the form of an inverted conical frustum, or any other shape sized to accept an alternatively shaped seal. In still further embodiments, other alternative forms of the depression (913) may be used and/or the depression (913) may be eliminated entirely if a seal can otherwise be formed to prevent process fluid from flowing beyond the access (911). Typically, the seal (923) engages the pressure sensor (901) and retains the sensor (901) in place with compression imparted onto the pressure sensing electronics (101) as the electronics (101) are sandwiched between the fitment portion (211) and the mount portion (311).

Typically, the pressure sensor (901) will be recessed from the main flow of the process stream going through the hollow bore (213) by being retracted slightly into the access (911) towards the hollow chamber (931). This positions the pressure sensor (901) generally perpendicular to the flow of the process stream in the hollow bore (213) and because the pressure sensor (901) sits in a slightly recessed position, the pressure sensor (901) senses the pressure tangentially to the flow of the process stream. Such an orientation can help prevent mechanical occlusion of the pressure sensor (901) and the access (911) which, in turn, facilitates preventing any unintended pressure drop that may occur across a pressure sensor (901) protruding into the hollow bore (213) and the process stream.

The circuit board (903), in the exemplary embodiment, includes any necessary circuit electronics and connections that are a part of the pressure sensing electronics (101) and that need to be provided prior to any external processing. The connections and circuit electronics, including the cable connector pins (905) generally simply enable the output of the pressure sensor (901) to be transmitted from the pressure sensor (901) to the cable connector pins (905). In the exemplary embodiment, the cable connector pins (905) are designed to electrically interconnect to the electrical interconnection components of a four-pin Molex™ MX150 connector. Alternatively, the cable connector pins (905) are designed to electrically couple to the electrical interconnection components of an M12 connector or cable assembly. Alternatively, the cable connector pins (905) may be designed to electrically couple with any other known electrical interconnection components. More specifically, as best seen in FIGS. 4 and 5, in the exemplary embodiment, the connector pins (905) extend upwardly from the circuit board (903) within the socket (397) and thus enable a connector, which will typically be attached to a cable, to mate and engage the connector pins (905) when the mating connector is inserted into the socket (397).

Such an interconnection will enable the signal from the pressure sensor (901) to be transmitted from the pins (905) via the cable to an attached computer or similar processing device for use. In the exemplary embodiment, the socket (397) is designed to be physically part of the housing (201) to avoid the need to include attaching a cable directly to the circuit board (903) as this can reduce cost and complexity of manufacture. In one embodiment, the socket (397) may be engaged by a cable and connector leading to an external output conditioning module to provide initial processing of the signal from the pressure sensor (901) which may then be transmitted from the output conditioning module for additional use.

Extra electronics on the circuit board (903) will typically be used to assist in pre-processing of the signal from the pressure sensor (901). Typically, pre-processing on the circuit board (903) will be kept to a minimum so as to not place any extra electronics on the circuit board (903) which are not strictly necessary to transfer the signal from the pressure gauge (901) through the pins (905). This facilitates enabling the circuit board (903) and, thus, the pressure sensing electronics (101), to be fabricated as inexpensively as possible.

FIG. 6 illustrates additional details of the space occupied by the circuit board (903) and the pressure sensor (901) in the fitment portion (211). The circuit board (903) will typically rest against a support shelf (943) that extends around, i.e., circumscribes, a hollow chamber (931) that includes the depression (913) and the access (911) in its base. There is also an internal shelf (933) that surrounds a portion of the hollow chamber (931) and that is recessed further into the fitment portion (211) than the support shelf (933) that surrounds the hollow chamber (931).

In the exemplary embodiment, the internal shelf (933) is generally “U-shaped” and thus extends along three sides of the chamber (931). On the fourth “open” side, and partially on two of the legs or attached sides, the chamber (931) does not include the internal shelf (933). The internal shelf (933) is generally sized and shaped to enable a tight fit with the pressure sensor (901) on the circuit board (903) which extends downwardly into the chamber (931) as best shown in FIG. 5 and into the access (911). Such an orientation facilitates securely engaging the pressure sensor (901) within the access (911) and the seal (923).

The support shelf (943) is sized and shaped to mate with the circuit board (903) and the circuit board (903) is sized to in close tolerance within the space above the support shelf (943). However, the support shelf (943) will generally not be used for self-alignment of the fitment (211) with the mount (311) except in rough positioning. Rather, the circuit board (903) positioned on the shelf (943) will generally only loosely fit with more precise alignment being performed by the cooperation of the mating pillars (233) and recesses (333), and the tightening of the screws (431) in the holes (231) and (331). The arrangement of the mating pillars (233) and recesses (333) when securely coupled together will, thus, facilitate self-aligning of the fitment portion (211) and the mount portion (311) and will also serve to securely sandwich the circuit board (903) between the base (319) of the mount portion (311) and the top of the support shelf (943). The pressure sensor (901) will be partially engaged by the internal shelf (933) such that the sensor extends into the access (911) engaging the seal (923) to substantially seal the hollow chamber (931) from fluids flowing through the bore (213).

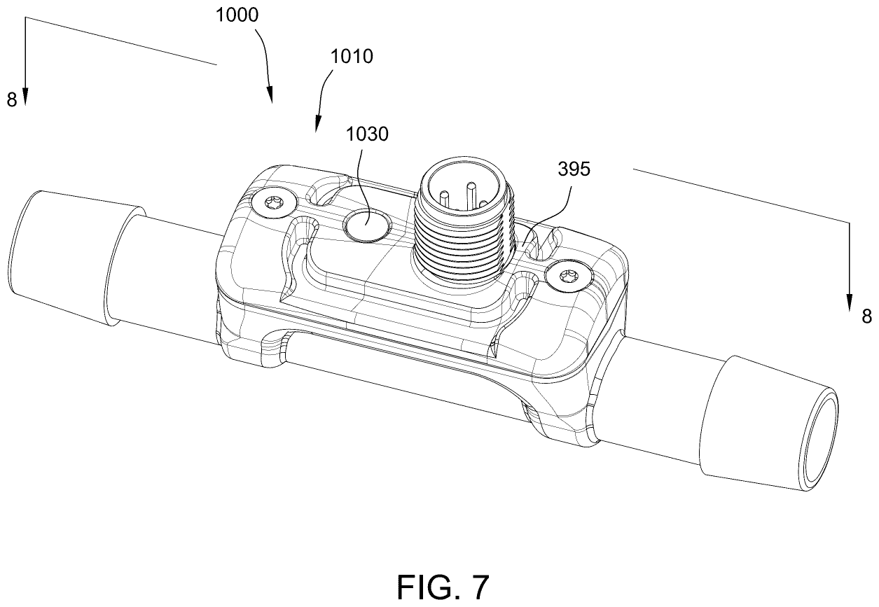

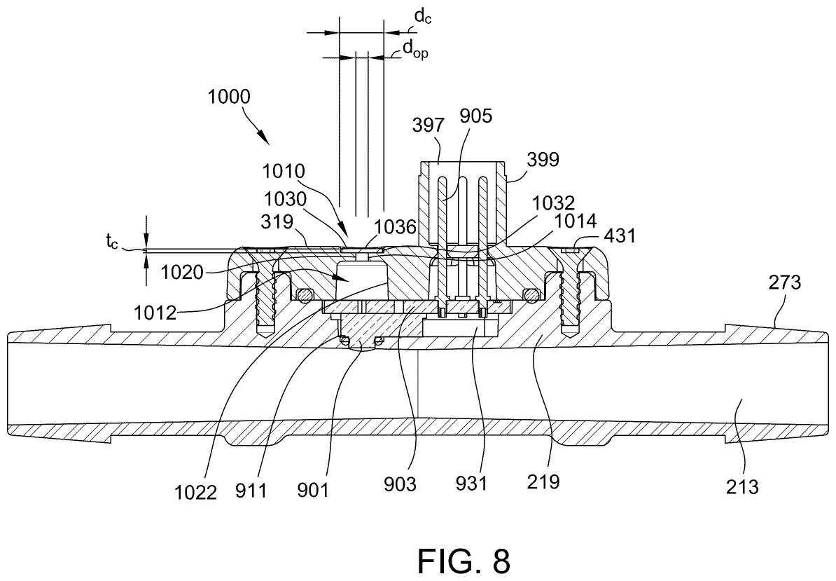

FIG. 7 is top perspective view of an alternative embodiment of a pressure gauge assembly (1000) with pressure sensing electronics (101) included therein. FIG. 8 is a cross-sectional view of the pressure gauge assembly (1000) shown in FIG. 7 and taken along line 8-8. Pressure gauge assembly (1000) is substantially similar to pressure gauge (100) shown in FIGS. 1-6 and components in FIGS. 7 and 8 that are identical to components of pressure gauge (100) are identified in FIGS. 7 and 8 using the same reference numerals used in FIGS. 1-6. Accordingly, pressure gauge assembly (1000) includes a two-piece housing (201) that includes a hollow bore (213) extending longitudinally through the fitment portion (211) of the housing (201). The mount portion (311) is coupled to the fitment portion (211), as described herein, such that a hollow chamber (931) and an access opening (911) are defined between the mount and fitment portions (311 and 211, respectively),

In the exemplary embodiment, pressure gauge assembly (1000) also includes a vent system (1010). More specifically, in the exemplary embodiment, the vent system (1010) includes a cavity (1012) and an outlet passage (1014) that extends from the cavity (1012) to the outer or base major surface (395). Cavity (1012) is sized with a pre-defined volume that facilitates equalizing the pressure between the pressure sensor (901) and the environment surrounding the pressure gauge assembly (1000), i.e., cavity (1012) facilitates pressure equalization). More specifically, the vent system (1010) enables the operating pressure within the housing (201) (i.e., within the hollow chamber (931)) to be substantially equalized with the surrounding environment.

In the exemplary embodiment, outlet passage (1014) is a substantially circular passage that has a substantially constant diameter dop. Alternatively, outlet passage (1014) may have any other cross-sectional shape and/or may be formed with any diameter dop including a variably changing diameter that enables the vent system (1010) to function as described herein. Moreover, in the exemplary embodiment, outlet passage (1014) is defined by a substantially smooth wall (1022) that facilitates preventing introducing any turbulence into air flowing through passage (1014).

Similarly, in the exemplary embodiment, cavity (1012) is defined by a substantially smooth interior wall (1022) that also facilitates preventing introducing any turbulence into air flowing through cavity (1012) into outer passage (1014) or from outlet passage (1014) into cavity (1012). In alternative embodiments, cavity (1012) and/or outlet passage (1014) may be defined by non-smooth walls, such as but not limited to textured walls, grooved walls, ribbed walls, and/or any other non-smooth walls that enable vent system (1010), and more specifically, pressure gauge assembly (1000) to function as described herein.

In addition, in the exemplary embodiment, cavity (1012) is formed with a pre-defined volume that not only facilitates equalizing the pressure between the pressure sensor (901) and the environment surrounding the pressure gauge assembly (1000), but that also facilitates accommodating pressure fluctuations that may occur within cavity (1022) or hollow chamber (931). More specifically, in the exemplary embodiment, the pre-defined volume facilitates accommodating any pressure fluctuations, including for example, but not limited to, pressure fluctuations that may occur as the temperature changes or as fluctuations occur within the chamber (931) during process measurements, such as may occur should the operating temperature of the pressure sensor (901) increase and/or should the air inside the hollow chamber (931) expand as the temperature increases, and/or should the operating pressure change due to any environmental influences.

In the exemplary embodiment, cavity (1022) has a substantially circular cross-sectional and is formed with a diameter de that is larger than outlet passage diameter dop. Moreover, in the exemplary embodiment, cavity (1022) is substantially symmetrical. In alternative embodiments, cavity (1022) may have any other size or shape that enables cavity (1022) and more specifically, pressure gauge assembly (1000) to function as described herein. For example, in some embodiments, cavity (1022) and/or outlet passage (1014) may be frusto-conical, tapered, contoured such as Coke-bottle shaped, cylindrical, and/or any other shape that enables vent system (1010) to function as described herein. Moreover, in some alternative embodiments, the cavity (1012) also includes a desiccant contained therein.

In at least some alternative embodiments, vent system (1010) does not include cavity (1022) and rather, outlet passage (1014) extends from outer or base major surface (395) to the hollow chamber (931). Moreover, in further alternative embodiments, vent system (1010) does not include outlet passage (1014) and rather, cavity (1022) extends from hollow chamber (931) to base major surface (395). In embodiments that include the cavity (1022) and the outlet passage (1014), vent system (1010) is designed such that the transition between cavity (1022) and outlet passage (1014) is substantially smooth and does not include any abrupt directional changes, squared-off corners, or sharp-defined edges. In each embodiment, vent system (1010), and more specifically, cavity (1022) and outlet passage (1014) are substantially concentrically aligned with respect to access (911). More specifically, such a relative orientation between vent system (1010) and access (911) enables optimizing the pressure equalization described herein between the pressure sensor (901) and the surrounding environment. In alternative embodiments, vent system (1010) and more specifically, cavity (1022) and/or outlet passage (1014) may be located at any location relative to access (911) that enables vent system (1010) and more specifically, pressure gauge assembly (1000) to function as described herein.

In the exemplary embodiment, vent system (1010) also includes a protective cover (1030) that extends across the outlet passage (1020) at the outer surface (395). Protective cover (1030) facilitates preventing the ingress of dust/debris and/or moisture into vent system (1010), while still enabling the pressure equalization described herein. The ingress of moisture and/or solid matter into vent system (1010) may have the potential of damaging the pressure gauge assembly (1000) and/or any of the pressure sensing electronics (101) housed therein, including the pressure sensor (901). More specifically, in the exemplary embodiment, cover (1030) is fabricated from a material having a low moisture vapor transmission rate that facilitates reducing the permeation of moisture into vent system (1010). For example, in one embodiment, cover (1030) is fabricated from a porous polymer material that has desired strength, durability, resiliency, and chemical resistance properties. Alternatively, cover (1030) may be fabricated from any material that facilitates preventing the undesirable ingress of dust/debris and/or moisture into vent system (1010).

In the exemplary embodiment, cover (1030) is substantially circular and is sized with a diameter that is larger than outlet passage diameter dop. Moreover, in the exemplary embodiment, cover (1030) has a shape that is substantially similar to the cross-sectional shape of outer passage (1020). In alternative embodiments, cover (1030) does not have the same shape as the cross-sectional shape of outer passage (1030) and may be formed with any other size or shape that enables cover (1030) to function as described herein. In the exemplary embodiment, the cover (1030) has a thickness t_{c}, a size, and a shape that enables the cover (1030) to fit snuggly within a counter-bore (1032) formed within surface (395). As such, in the exemplary embodiment, the counter-bore (1032) is formed with a depth, size, and shape that enables cover (1030) to be seated fully, (i.e., secured) within the counter-bore (1032) such that an outer surface (1036) of the cover (1030) is substantially co-planar with surface (3950. Alternatively, in some embodiments, vent system (1010) does not include counter bore (1032). Moreover, in other alternative embodiments, counter-bore (1032) may be formed with any other depth, size, and/or shape that enables vent system (1010) to function as described herein.

In the exemplary embodiment, cover (1030) is securely coupled within counter-bore (1032) and is not removable from vent system (1010). For example, in one embodiment, cover (1030) is secured within the counter-bore (1032) via an adhesive or a glue. Alternatively, cover (1030) may be secured in position using any known coupling method that enables cover (1030) and vent system (1010) to function as described herein.

Because the cover (1030) enables pressure equalization to occur between the pressure sensor (901) and the surrounding atmosphere. Moreover, the combination of the cavity (1022) and the outlet passage (1014) facilitates improving the accuracy of the pressure sensor (901) while reducing the potential adverse effects that may occur from pressure and/or temperature fluctuations within the hollow chamber (931). As a result, pressure monitoring of the process stream is facilitated to be more accurate, more reliable, and in a more cost-effective manner as compared to pressure sensors that do not include vent system (1010).

The exemplary systems and methods described and illustrated herein provide a pressure gauge assembly that facilitates enhanced accuracy of pressure measurements of the process stream flowing through the bore (213). Moreover, the combination of the geometry of the vent system and the protective cover facilitates ensuring that pressure equalization occurs between the pressure sensor and the surrounding environment, while reducing the risk of moisture and/or debris ingress into the pressure gauge assembly in a cost-effective and reliable manner. In addition, the pressure gauge assembly described herein is assembled in a murphy-proofed, self-aligning configuration that facilitates reducing human assembly errors, facilitates reducing fabrication costs to the process user, and that facilitates enhancing the accuracy of pressure monitoring.

Exemplary embodiments of systems and methods for pressure gauge assemblies are described above in detail. The systems and methods of this disclosure though, are not limited to only the specific embodiments described herein, but rather, the components and/or steps of their implementation may be utilized independently and separately from other components and/or steps described herein.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

Although specific features of various embodiments may be shown in some drawings and not in others, this is for convenience only. In accordance with the principles of the systems and methods described herein, any feature of a drawing may be referenced or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A pressure gauge comprising:
a housing including a hollow bore extending therethrough, said housing comprising:
a first connector;
a second connector opposite said first connector, said first connector concentrically aligned with the hollow bore for allowing fluid to enter the hollow bore, said second connector concentrically aligned with the hollow bore for allowing fluid to exit the hollow bore;
an access oriented generally perpendicularly to said hollow bore;
a hollow chamber defined therein; and
a vent system comprising an opening and a protective cover, said vent system opening substantially concentrically aligned with said pressure sensor, said protective cover extending across said vent system opening; and
a pressure sensor positioned within said access and recessed from said hollow bore, said hollow chamber sized to contain said pressure sensor therein.

2. The pressure gauge in accordance with claim 1 wherein said protective cover substantially prevents an ingress of at least one of solid debris and liquid into said vent system.

3. The pressure gauge in accordance with claim 1 wherein said protective cover facilitates extending a useful life of said pressure sensor.

4. The pressure gauge in accordance with claim 1 wherein said protective cover is fabricated from a material having a low moisture vapor transmission rate that facilitates reducing a permeation of moisture into said vent system.

5. The pressure gauge in accordance with claim 1 wherein said protective cover is fabricated from a porous polymer material.

6. The pressure gauge in accordance with claim 1 wherein said vent system opening is defined in an outer surface of said housing, said protective cover has a shape that is substantially similar to a cross-sectional shape of said vent system opening.

7. The pressure gauge in accordance with claim 1 wherein said vent system opening is defined in an outer surface of said housing, said protective cover has a shape that is different than a cross-sectional shape of said vent system opening.

8. The pressure gauge in accordance with claim 1 wherein said vent system further comprises a counter-bore defined in said housing and substantially concentrically aligned with respect to said vent system opening, said opening is sized to receive said protective cover therein such that an outer surface of said protective cover is substantially co-planar with an outer surface of said housing when said protective cover is fully seated therein.

9. The pressure gauge in accordance with claim 1 wherein said vent system comprises a cavity having a pre-defined volume, said cavity substantially concentrically aligned with respect to said pressure sensor.

10. The pressure gauge in accordance with claim 9 wherein said cavity facilitates equalizing the pressure between said pressure sensor and the environment surrounding the pressure gauge.

11. The pressure gauge in accordance with claim 9 wherein said vent system facilitates accommodating pressure fluctuations within said hollow chamber.

12. The pressure gauge in accordance with claim 9 wherein said cavity facilitates increasing an accuracy of pressure measurements by said pressure sensor.

13. The pressure gauge in accordance with claim 9 further comprising an outlet passage extending substantially concentrically from said cavity to said vent system opening.

14. The pressure gauge in accordance with claim 13 wherein at least one of said cavity and said outlet passage are defined by smooth walls.

15. The pressure gauge in accordance with claim 9 wherein said cavity is one of frusto-conical and cylindrical shaped.

16. A pressure gauge for use in measuring the pressure of a fluid, said pressure gauge comprising:
a housing including a hollow bore extending therethrough, said housing comprising:
a first connector;
a second connector opposite said first connector, said first connector concentrically aligned with the hollow bore for allowing fluid to enter the hollow bore, said second connector concentrically aligned with the hollow bore for allowing fluid to exit the hollow bore; and
an access oriented generally perpendicularly to said hollow bore;
a hollow chamber defined therein, said hollow chamber sized to contain said pressure sensor therein; and
a vent system comprising an opening, a cavity, and a protective cover, said vent system opening substantially concentrically aligned with said pressure sensor, said protective cover extending across said vent system opening, said cavity having a pre-defined volume between said pressure sensor and said vent system opening, said cavity sized to facilitate equalizing the pressure between said pressure sensor and the environment surrounding the pressure gauge; and
a pressure sensor positioned within said access and recessed from said hollow bore, said pressure sensor for measuring pressure of the fluid flowing through said hollow bore.

17. The pressure gauge in accordance with claim 16 wherein said vent system facilitates accommodating pressure fluctuations within said hollow chamber, said vent system further comprises an outlet passage extending from said cavity to said opening.

18. A method of fabricating a pressure gauge for use in measuring pressure flowing through said pressure gauge, said method comprising:
providing a lower housing portion including a hollow bore extending therethrough, the hollow bore sized to enable fluid to flow therethrough from a first end to a second end of the hollow bore;
coupling a pressure sensor within an access defined within the housing such that the pressure sensor is recessed from the hollow bore and is positioned to take pressure measurements of fluid flowing through the hollow bore;
forming a vent system in an upper portion of the housing wherein the vent system has an opening that is exposed to the ambient environment and a cavity having a pre-defined volume that is substantially concentrically aligned with the pressure sensor when the housing is fully assembled;
coupling the upper portion of the housing to the lower portion of the housing such that the pressure sensor is contained in position within the access and such that the vent system opening is substantially concentrically aligned with respect to the pressure sensor; and
coupling a protective cover to the vent system to prevent ingress into the vent system opening.

19. A method in accordance with claim 18 wherein coupling a protective cover to the vent system further comprises positioning the protective cover to facilitate pressure equalization between the pressure sensor and the surrounding ambient environment.

20. A method in accordance with claim 18 wherein forming a vent system in an upper portion of the housing further comprises forming the cavity with a pre-defined volume that is sized to facilitate reducing pressure fluctuations within the cavity.
